(19) United States
(12) Patent Application Publication
(10) Pub. No.: US 2013/0297430 A1
(43) Pub. Date: Nov. 7, 2013

(54) LINKABLE SMART TAGS

(71) Applicant: Richard C. Soergel, San Diego, CA (US)

(72) Inventor: Richard C. Soergel, San Diego, CA (US)

(21) Appl. No.: 13/738,705

(22) Filed: Jan. 10, 2013

Related U.S. Application Data
(60) Provisional application No. 61/641,070, filed on May 1, 2012.

(51) Int. Cl. G06Q 30/02; G06K 19/06; G06F 17/30

(52) U.S. Cl. CPC G06Q 30/0277; G06K 19/06046; G06K 19/06037; G06F 17/30879; G06K 19/06028
USPC 705/14.73; 235/487; 235/494; 235/375

(57) ABSTRACT

Device for distribution of promotional material is disclosed that allows distribution of web based content through the capture or scan of a machine readable Quick Response Code with a portable electronic device such as a smartphone. A method and system are disclosed that access and display on-line promotional content through the scanning of a novelty device or tag containing an imprint of a machine readable Quick Response Code. The consumer/user scans the Smart Code (or QR code) and lands on a special offer page and then the brand can capture the digital profile of the consumer once they opt into the offer.

### CROSS-REFERENCE TO RELATED APPLICATIONS

This application claims the benefit of U.S. Provisional Application No. 61/641070 filed May 1, 2012, the entirety of which is incorporated by reference herein.

### BACKGROUND OF THE DISCLOSURE

1. Field of the Disclosure

The present invention relates to tags or other devices that include machine readable (or scannable) codes that provide links to on-line content and, in particular, tags or other devices with machine readable (or scannable) smart codes. These machine readable smart codes can be programmed to provide a link to a website, landing page, SMS (text), Message or Phone number that contains content related to a promotional activity such as coupons, promotions, online ordering, data capturing, free downloads, discounts, specials prizes, etc. The distributor or brand can then capture the profile of the smart phone user and then market back forth as they like.

2. Description of the Related Art

Promotional materials and products are often a necessary component of a marketing plan. Often, promotional materials, including coupons, give-aways, packaging, etc. are expensive and not very effective as the promotional materials are limited to what is originally printed on the materials. These materials can become outdated very quickly and don't allow the distributor or the brand much flexibility to alter or extend the offer once the promotional materials have been provided.

Moreover, the materials themselves often come in the form of paper coupons, stickers and the like. These items are not very substantial and are often viewed as trash by the recipients which, in turn, makes the recipients less likely to retain and make use of the promotional material. For example, a coupon that offers a free item, such as a drink at a restaurant, may be easily misplaced or discarded by the recipient of the coupon, thus limiting the effectiveness of the promotional material or offer.

To this end, there is a need for promotional materials and/or products that are more permanent in nature. Further, there is a need for promotional materials that can be easily and flexibly altered by the distributor (or brand) to provide the distributor with greater flexibility when distributing the promotional materials. To this end, there is a need for promotional materials, offers and/or products that are more permanent in nature.

### SUMMARY OF THE INVENTION

In one embodiment, a device for distribution or delivery of promotional information or materials through an imprinted graphic icon on one side and a smart code on the second side that can be read by a portable electronic device. The device can be produced in the form of a physical tangible device, such as a tag (in any shape or size), keychain, or medallion in aluminum, metal, rubber or plastic. This physical device or tag can be imprinted with the brand identity. Moreover, the imprinted graphic icon can be in the form of a scannable code, such as a one dimensional bar code or a Quick Response Code (QR Code). The scannable code may be configured to be read by a portable electronic device such as a smart cell phone and provide a link to a website, landing page, SMS (text), Message or Phone number or its equivalent. This link to a website, landing page, SMS (text), Message or Phone number or its equivalent may provide the recipient with promotional materials. Moreover, in some embodiments the device contains a coupling mechanism or connection which allows the user to easily retain the device for future use by attaching the device to a key chain or other personal item. Once the QR code is scanned, the information, offer, coupon or product remains on the user's/consumer's smart phone for future access and when they scan the Smart code again, they can access the NEW special offers, discounts, coupons, etc.

### BRIEF DESCRIPTION OF THE DRAWINGS

FIG. 1A illustrates an embodiment of one surface of a device in the form of a tag containing a machine readable code.

FIG. 1B illustrates an embodiment of the second surface of a device in the form of a tag containing an imprint of brand identity.

FIG. 2 is a diagram depicting one embodiment of a system for distributing promotional material.

FIG. 3 is a block diagram illustrating one embodiment of a method for promoting a website or business.

FIG. 4 illustrates an embodiment of a tag in use with a keychain.

### DETAILED DESCRIPTION OF THE PREFERRED EMBODIMENT

The aforementioned needs are addressed by the present invention which, in one embodiment, comprises a physical tag (in any shape or size) or medallion that has imprinted on it a graphic icon that can be read by a portable electronic device such as a smart phone. The graphic icon provides a link to a website, landing page, SMS (text), Message or Phone number or its equivalent, which can then provide the recipient with the promotional material. On the other side is the brand's logo, image, or message.

In this way, a tangible physical device 100, such as a tag, a key chain, etc. with a brand can then be distributed to the recipient or consumer. As this item is a more substantial physical item, it is less likely to be misplaced or discarded by the recipient and, if used as a keychain, stays with the recipient (or consumer). Moreover, since the graphic icon is linked to a website, landing page, SMS (text), Message or Phone number, the distributor or brand of the promotional materials can change what is being distributed or offered by simply changing the website. Thus, the promotional tags can be used for the distribution of a wide variety of different promotional materials without requiring the tags themselves to be changed. Once the QR code is scanned, the information or landing page remains on the user's smart phone or portable electronic device for future access. More specifically, once the QR code is scanned, the information, offer, coupon or product remains on the user's/consumer's smart phone for future access and when they scan the Smart code again, they can access the NEW special offers, discounts, coupons, etc.

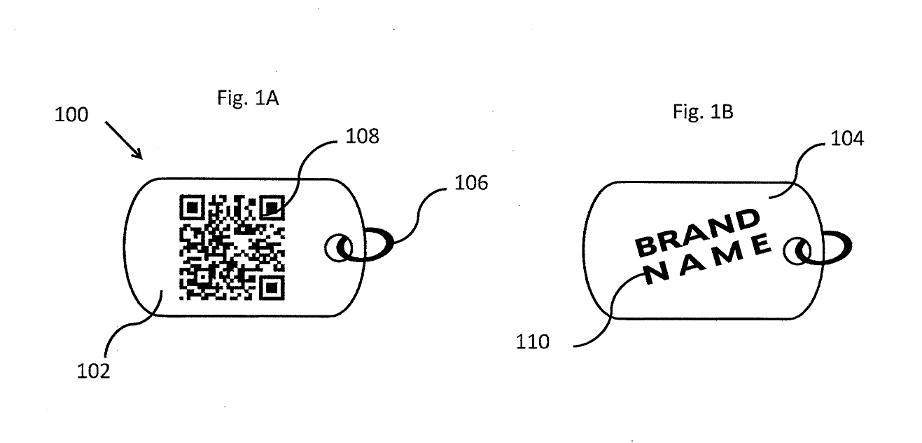

FIG. 1A illustrates an embodiment of one surface 102 of a device 100 in the form of a tag. The tag may include an attachment assembly 106. The device may contain a scannable code 108 imprinted on the device and readable by a portable electronic device such as a smart cell phone. Additionally, in some embodiments the surface of the device with the scannable code can also contain promotional information or brand identifiers within the code or adjacent to the code.

In one exemplary implementation, the scannable code 108 or graphic icon can comprise a one dimensional bar code or a Quick Response Code (QR Code) that is adapted for use by mobile devices or portable electronic devices such as smart cell phones. As is understood, QR codes are commonly used to provide addresses to websites when these codes are printed in magazines and the like. The user simply captures an image of the QR code or scannable code 108 via their mobile device and the mobile device then translates the visual icon or code 108 into a web address and accesses the web address which is then displayed on the mobile device (i.e., if McDonalds used the tags with their image on one side and a scannable code (QR) on the back, the customer would scan and then be taken to specials, events, offers, prizes instantly by simply scanning the code). The QR code or scannable code 108 can be imprinted onto tags, dog tags, key chains, etc. which can then provide a direct link to a website or landing page from which prizes, coupons, tickets, discounts, offers, marketing information, and the like can be distributed. Items such as coupons, promotions, online ordering, data capturing, free downloads, discounts, specials, prizes, maps, information, etc. can be distributed through the target website or landing page.

FIG. 1B illustrates an embodiment of the second side 104 of a device 100 in the form of a tag. The second side 104 of the device 100 can display a brand name, logo, message, or other identifying or promotional characteristics 110 to identify the device with the distributing entity. The advertising material or promotional information graphics can be in color, ranging from one color to full color.

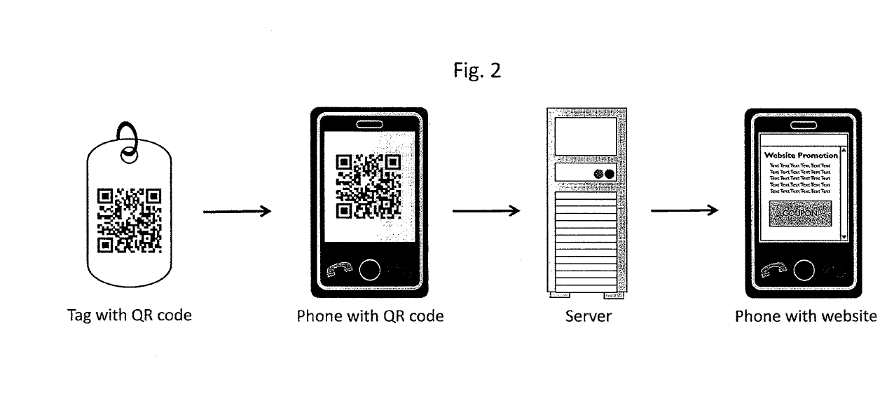

FIG. 2 is a diagram depicting one embodiment of a system for distributing promotional material. The user simply captures an image of the QR code or scannable code 108 imprinted on the device 100 via their mobile device. The mobile device then translates the visual icon or code 108 into a web address accessing a remote server to display the website or landing page on the mobile device. Additionally, once the QR code is scanned, the information or landing page remains on the user's smart phone or portable electronic device for future access.

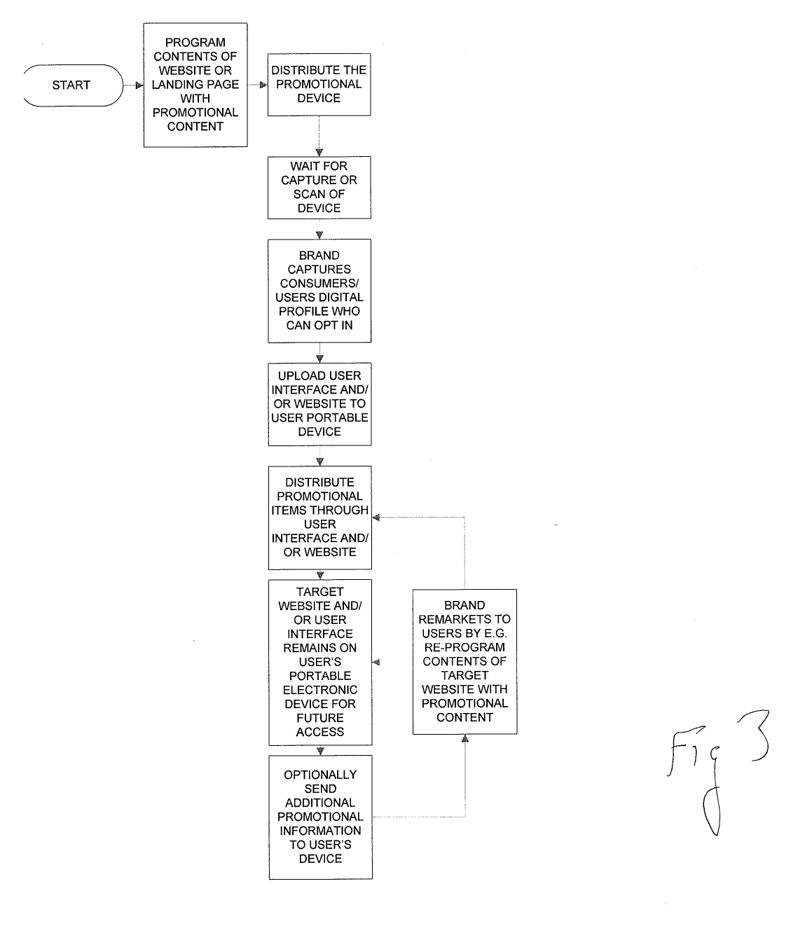

FIG. 3 is a block diagram illustrating one embodiment of a method for promoting a website or business. The distributor (or brand) or a website manager may program the target website or landing page with the desired promotional content. The device 100 can be distributed in one single event or point of contact with the user. The user can capture or scan the QR Code on the device 100 and the user's portable electronic device or mobile device is linked to the on-line promotional material. Once the QR code is scanned, the information or landing page or some sort of user access interface remains on the user's smart phone for future access. Additionally, the consumer or user scans the Smart Code (or QR code) and lands on a special offer page and the brand can capture the digital profile of the consumer or user once they opt into the offer. The distributor or brand can alter the promotional materials available on the website by changing the content of the website or landing page without changing or redistributing the tag. Thus, the distributor can alter a marketing campaign very easily by a simple modification of the content of a website or landing page and even send back a text message to the consumer once their profile is captured. The website accessed by the mobile device can contain various marketing materials which can be varied or changed by the brand or distributor at any time. Additionally, in some embodiments the graphic icon or scannable code 108 can be linked to a website, landing page, SMS (text), Message or Phone Number what will provide the recipient with the promotional material.

Moreover, the promotional or novelty materials simplify user access to the distributor's website. The recipient of the tag no longer has to memorize or record the website, the visual icon provides a direct link to the website or landing page via the user's mobile device. Thus, the system and method of distributing promotional materials is more flexible and also results in greater utilization of the promotional materials and the recipient is receiving a more substantial tangible item. In some embodiments, the device 100 can be created from a durable sustainable material, such as an aluminum, metal, rubber or plastic. This item is a more substantial physical item and therefore is less likely to be misplaced or discarded by the recipient. Additionally, the distributor has flexibility in the types of materials and promotions that can be offered to the recipient through the on-line content. These materials or promotions may include: providing admission to concerts, movies, events, parties, and travel destinations; distributing a message, a listing of a company URL, or a coding of a company phone number for instant communication of message to user; offering an incentive, a discount, and a special; a method of connecting an employer to access a resume; and connecting potential colleagues for networking purposes. In addition, coupons, promotions, online ordering, data capturing, free downloads, discounts, specials, prizes, maps, information, etc. can be offered via the website or landing page.

Further, the system or brand captures the user's profile and their smart phone information, provided that the user has opted in by filling out a form or providing digital consent. This allows the system or brand to market to the user in the future by sending additional advertisements or updating the information that is has been downloaded to the user's personal electronic device. The user's information that is captured can be quite detailed as the user is responding to a particular advertisement and the system can then tailor future promotional materials sent to this user accordingly.

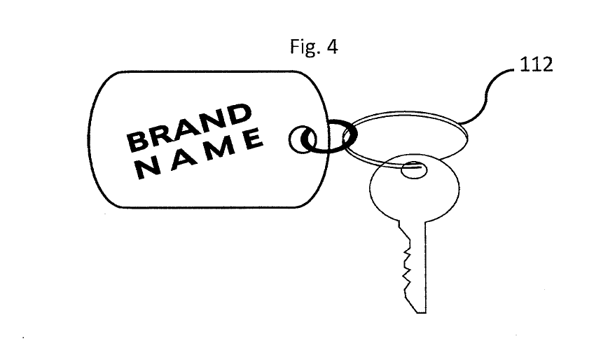

Additionally, in some embodiments this durable physical device can be used as a keychain which allows the device to stay with the recipient or consumer. FIG. 4 illustrates an embodiment of a tag in use with a keychain. In some embodiments, the tag may include an attachment assembly 106 that allows the tag to be attached to a key ring 112, keychain, ballchain, or any other item of a user. In some embodiments, the attachment or retention of the device to the user's personal items can allow for continued marketing past the point of contact and distribution of the marketing materials to the user.

It will be appreciated that various changes and substitutions to the devices described herein and the uses thereof may be made by those skilled in the art without departing from the spirit of the present teachings. Hence, the scope of the present invention should not be limited to the foregoing discussion but should be defined to the broadest extent permissible under the law and as understood by a person of ordinary skill in the art.

What is claimed is:

1. A distributed novelty device comprising:
a first surface and a second surface;
a first surface consisting of an advertising component or a promotional information component, wherein the advertising component or the promotional information component consists of a color graphic;
a second surface containing a machine readable code, the machine readable code configured to be captured and read by a portable electronic device, wherein the machine readable code provides a link, the link configured to direct the portable electronic device to an on-line content; and
an on-line content configured to remain on the portable electronic device.

2. The distributed novelty device of claim 1, wherein the machine readable code comprises a Quick Response (QR) Code, an NPC code or a UPC code.

3. The distributed novelty device of claim 1, wherein the first and second surface are formed from a hard, durable material comprising an aluminum, a metal, a rubber, or a plastic, wherein the material can withstand puncture or distortion during transportation and use.

4. The distributed novelty device of claim 1, wherein the advertising component or the promotional information component consists of the color graphic ranging from one color graphic to full color graphics.

5. The distributed novelty device of claim 1, wherein the distributed novelty device is a dog tag or keychain.

6. The distributed novelty device of claim 1, wherein the on-line content is configured to be altered or changed throughout the use of the distributed novelty device.

7. The distributed novelty device of claim 1, wherein the on-line content comprises a website, landing page, SMS (text), or Message or Phone number.

8. The distributed novelty device of claim 1, wherein the on-line content is configured to distribute a promotional item comprising coupons, promotions, online ordering, data capturing, free downloads, discounts, specials, prizes, maps, and information.

9. The distributed novelty device of claim 1, wherein a coupling member is securely attached to the distributed novelty device, the coupling member configured to be connected to a keychain or ballchain.

10. A system for distributing promotional products and information comprising:
a target website or a landing page configured to connect to the world wide web and managed by a website manager;
a remote server configured to store data relating to the target website and transmit data to the target website;
a distributed novelty device comprising a first surface and a second surface, the first surface containing an advertisement, the second surface containing a machine readable code, the machine readable code causing a portable electronic device to display the target website; and
a target website configured to remain on the portable electronic device upon the portable electronic device accessing the target website.

11. The system of claim 10, wherein the machine readable code comprises a Quick Response (QR) Code, an NPC code or a UPC code.

12. The system of claim 10, wherein the first and second surface of the distributed novelty device are formed from a hard, durable material comprising an aluminum, a metal, a rubber, or a plastic, wherein the material can withstand puncture or distortion during transportation and use.

13. The system of claim 10, wherein the advertisement consists of a color graphic ranging from one color graphic to full color graphics.

14. The system of claim 10, wherein the distributed novelty device is a dog tag or keychain.

15. The system of claim 10, wherein the target website is configured to be accessed through capture of the machine readable code configured to direct linkage to a website, landing page, SMS (text), or Message or Phone number.

16. The system of claim 10, wherein the target website is configured to distribute a promotional item comprising coupons, promotions, online ordering, data capturing, free downloads, discounts, specials, prizes, maps, and information.

17. A method of promoting a website or business comprising:
selectively programming or controlling a target on-line content, the target on-line content configured to be changed or altered by a website manager;
distributing a distributed novelty device containing a first and second surface, the first surface containing an advertising material, the second surface containing a machine readable code;
receiving a capture or a scan of the machine readable code by a portable electronic device;
directing the portable electronic device to the target on-line content configured to cause the display of a user interface comprising a promotional item; and
transmitting the promotional item through the target on-line content, the target on-line content configured to remain on the portable electronic device.

18. A method of claim 17, wherein the target on-line content is configured to be accessed through capture of the machine readable Quick Response (QR) Code, an NPC code or UPC code configured to direct linkage to a website, landing page, SMS (text), or Message or Phone number.

19. A method of claim 17, wherein the target on-line content is configured to distribute a promotional item comprising coupons, promotions, online ordering, data capturing, free downloads, discounts, specials, prizes, maps, and information.

20. A method of claim 17, wherein the target on-line content comprising one or more of:
an admission to concerts, movies, events, parties, and travel destinations;
a message, a listing of a company URL, or a coding of a company phone number for instant communication of message to user;
an incentive, a discount, and a special;
a connection for employers to access a resume; and
a connection for networking with potential colleagues.

21. A method of claim 17, wherein the distributed novelty device is a dog tag or keychain.

22. The method of claim 17, further comprising enrolling the portable electronic device upon the portable electronic device opting into the system and providing updated promotional items to the enrolled portable electronic device.

23. The method of claim 22, further comprising downloading a website onto the enrolled portable electronic device that can be updated by the system.
